(19) United States
(12) Patent Application Publication
(10) Pub. No.: US 2007/0110854 A1
(43) Pub. Date: May 17, 2007

(54) Food Bag With a Natural Preservative For Providing Extended Shelf-Life

(76) Inventor: Perry S. Bagley, Cumming, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/555,435

(22) Filed: Nov. 1, 2006

Related U.S. Application Data
(60) Provisional application No. 60/732,494, filed on Nov. 2, 2005.

(51) Int. Cl. A23B 7/148

(52) U.S. Cl. 426/106

(57) ABSTRACT

A multi-layered food packaging bag or pouch including one or more preservatives for extending the shelf-life of fresh food products is provided. A multi-layered food packaging film or overwrap including one or more preservatives for use in conventional food packaging and for extending the shelf-life of fresh food products is also provided. Suitable preservatives include natural preservatives, although synthetic preservatives may be used.

### CROSS-REFERENCE TO RELATED APPLICATIONS

This application claims priority to copending U.S. provisional patent application Ser. No. 60/732,494, entitled “FOOD BAG WITH NATURAL PRESERVATIVE FOR PROVIDING EXTENDED SHELF-LIFE” filed on Nov. 2, 2005 and incorporated herein by reference in its entirety.

### FIELD OF THE INVENTION

The present invention relates to a fresh food packaging, in particular multi-layered plastic food bags or pouches, of the type used to contain and display fresh food products, in particular fresh meat and produce products, including a natural preservative and providing enhanced shelf-life for the product.

### BACKGROUND OF THE INVENTION

It is known to package fresh food products, in particular meat such as beef, poultry, pork and seafood, cheese, and fresh produce in flexible plastic bags or pouches, particularly multiple-walled plastic bags, to preserve freshness. Such bags are known, for example from U.S. Pat. Nos. 4,481,669, 3,494,457 and 3,559,800, which are hereby incorporated by reference.

It is also known that the use of certain preservatives on food products will help to maintain freshness and thereby increase the shelf-life of the food products. While some grocery items, particularly those that are preserved by freezing, drying, smoking, pickling or canning, do not require the use of preservatives, such preservatives are useful for fresh food products to slow spoiling and inhibit the growth of microorganisms. Three general categories of food preservatives include antimicrobials (e.g. sulfur dioxide or sulfites, propionates, benzoates, and nitrites) that inhibit growth of various microorganisms; antioxidants (e.g. butylated hydroxytoluene, tert-butylhydroquinone, and propyl gallate) that slow air-induced oxidation of fats and lipids to prevent rancidity; and preservatives (e.g. phenolase, citric acid and ascorbic acid) that block the natural ripening and enzymatic changes in foods such as fresh produce.

Some preservatives fall into more than one of the above categories. Sulfites, for example, serve all three functions, but some consumers are sensitive to sulfites and experience adverse reactions from consumption of a product preserved with sulfites. As a result, the FDA has banned the use of some sulfites with certain foods, such as fresh cut fruits and vegetables. Another multi-purpose preservative is citric acid or citrate, which serves both as a natural antimicrobial for various food products and as an agent to prevent the enzymatic browning of cut fruits and vegetables.

While flexible bags for packaging food products and various preservatives have separately served to improve the shelf-life of various food products somewhat, there remains a need for improved, longer shelf-life for the fresh food products to be packaged.

### SUMMARY

The present disclosure provides packaging for food products that increases the shelf-life of the food products, particularly fresh meat and produce products, such as fresh fruit, beyond that provided by the aforementioned packaging by utilizing preservatives in the packaging.

The packaging of the present disclosure includes a flexible bag or pouch constructed of a multi-layer film with a layer or coating of one or more preservatives disposed between an inner semi-permeable layer and at least one outer layer of the bag. It is intended that the food product be inserted in the interior of the bag, defined by the semi-permeable layer. It is further intended that moisture from within the bag, for example, from the food product, is capable of diffusing through the semi-permeable inner bag layer and communicating with the preservative layer or coating, whereby a preservative vapor is formed that is capable of diffusing back through the semi-permeable inner bag layer to the food product.

In one embodiment the preservative(s) is a natural preservative, such as a naturally occurring acid such as citric acid or a salt thereof such as sodium citrate. The natural preservative(s) can be provided as a composition including one or more naturally occurring acids or salt(s) thereof and an oxidation reduction agent. Active acid or a salt thereof such as phosphoric acetate can be used as a preservative either in place of citric acid or in addition to citric acid. Other natural or synthetic (also known as “chemical”) preservatives can also be used in the packaging of the present disclosure.

In a further embodiment, the packaging includes a multi-layered film, as described above, used to cover a tray containing a food product. The film may also be offered and sold separately, or together, with the other packaging components.

It can be seen, therefore, that a method for packaging a fresh food product is also provided in which the preservative-containing bag or film of the present disclosure is used to package and display the fresh food product.

Other packaging systems, devices, features and advantages of the disclosed packaging will be or become apparent to one with skill in the art upon examination of the following drawings and detailed description. It is intended that all such additional systems, devices, features, and advantages be included within this description, be within the scope of the present invention, and be protected by the accompanying claims.

### BRIEF DESCRIPTION OF THE DRAWING

Many aspects of the disclosed packaging can be better understood with reference to the attached drawing, FIG. 1. The components in the drawing are not necessarily to scale, emphasis instead being placed upon clearly illustrating the principles of the present invention. While an exemplary embodiment is disclosed in connection with the drawing, there is no intent to limit the disclosure to the embodiment or embodiments disclosed herein. On the contrary the intent is to cover all alternatives, modifications and equivalents.

FIG. 1 is a side cross-sectional view of the food bag of the present disclosure including a multi-layered bag, with a layer of preservative disposed between two layers of the multi-layered bag.

### DESCRIPTION OF THE EXEMPLARY EMBODIMENT

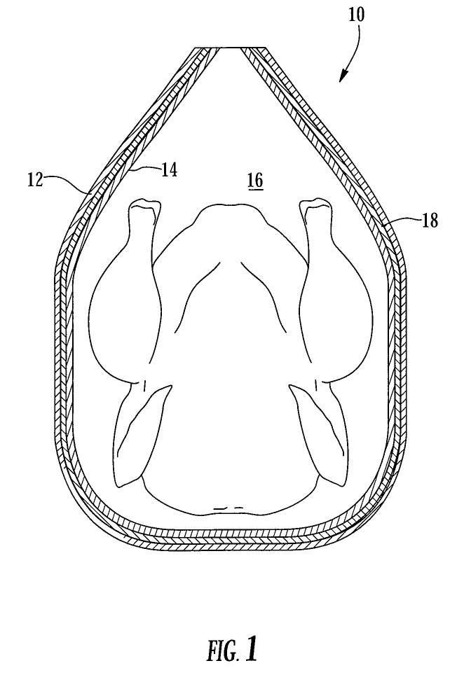

Referring more specifically to the drawing, an exemplary embodiment of the packaging of the present disclosure is illustrated in FIG. 1. As shown, the bag 10 is a multi-walled plastic bag having at least two layers, an outer layer 12 and an inner layer 14, defining a bag interior portion 16. The bag of the present disclosure also includes a coating of one or more preservatives, disposed between outer layer 12 and inner layer 14 of the bag 10, forming preservative layer 18. Preferably, preservative layer 18 is applied on the inside surface of outer layer 12 of the bag, although the preservative may optionally be applied to the outer surface of inner layer 14 of the bag. The bag may also include additional outer layers, not shown.

In order for the preservative to be in communication with the food product contained within the bag, the inner layer 14 is semi-permeable to moisture (e.g., in the form of water vapor) and gas (e.g., oxygen, air). Thus, in embodiments, the semi-permeable inner layer 14 is made of a porous, semi-permeable, “breathable,” or otherwise water-vapor permeable material that is compatible with the food products intended to be contained in the bag. Suitable materials include, for example, films of polyvinyl chloride (PVC), polyethylene, polypropylene, drawn polyamide, polymers containing polyamide blocks and polyether blocks, polyolefins, and the like. Such films are known in the art, as described in U.S. Pat. No. 5,888,597 (polymer-based thermoplastic film for packaging materials that is permeable to water vapor), Canadian patent application CA 1,324,476 (multi-layer packages with a perforated first film and a second multi-layered film), Japanese patent application JP 05 230 235 (perforated polyethylene-based films for packaging produce and permeability to oxygen and water-vapor), which are hereby incorporated by reference. Moisture from the interior of the bag, for example from the food product, is thus able to diffuse through inner bag layer 14 and communicate with preservative layer 18. The interaction of the moisture and the preservative creates a preservative-containing vapor which is then able to diffuse back through the permeable inner bag layer 14 to the bag interior 16 containing the food product. This preservative-containing vapor helps to preserve the food product and provides an extended shelf-life for the product.

The outer layer(s) of the bag (e.g., outer layer 12 shown in FIG. 1) may be formed of various suitable materials depending on the intended use of the bag. The type of material and complexity of the composition of the outer ply is dictated in each case by the stringency of the requirements for adequate protection of the flavor, moisture content, and freshness of the product to be packaged, as well as the particular necessity for flexibility, printing characteristics, and durability in a given packaging situation. The outer layer(s) are preferably substantially impermeable to moisture (e.g., water, other liquids, and water vapor); however, other characteristics of the outer layer, such as gas permeability, may vary depending on the intended use of the bag or film.

For instance, when packaging fresh lettuce or other fresh produce, it is preferable to construct the outer layer(s) of the packaging from films with a substantial degree of oxygen and/or carbon dioxide permeability. Oxygen permeable multilayer films are known in the art and are described in U.S. Pat. Nos. 6,060,136 and 6,517,950, which are hereby incorporated by reference. Other constructions may be more suitable when packaging fresh meats. When packaging bone-in meats, for instance, tougher materials may be desirable to prevent punctures, and a patch construction, such as described in U.S. Pat. No. 6,790,469, hereby incorporated by reference, may be used. Additionally it may be desirable that the outer layer(s) be impermeable when packaging fresh meats, or otherwise have a high barrier resistance to air or oxygen. Examples of suitable impermeable packaging films include single and multilayer films made of substantially oxygen impermeable materials such as polyehtylene, and may include layers of amorphous nylon, such as the films described in U.S. Pat. Nos. 5,051,525 and 4,911,963, which are hereby incorporated by reference. Another example of a substantially impermeable film material that can be used for the outer layer(s) of the packaging of the present disclosure is a coextruded barrier film commercially available as product no. 325C44-EX861 B from PrintPack, Inc. of Atlanta, Ga.

Other packaging films suitable for constructing bags for containing fresh food products are known to those of skill in the art, and may include for example, the films described in U.S. Pat. Nos. 5.843,581, 4,481,669 and 3,559,800, which are hereby incorporated by reference. The outer layer(s) or ply(s) of such packages are generally made of a flexible packaging material such as a synthetic polymeric film, ethylene/vinyl acetate (EVA) films, printed paper laminates combined with any of a variety of other materials such as metal foil, polyethylene, petroleum waxes, polyvinylidine chloride or other similar materials compatible with the food products intended to be contained in the bag and capable of forming protective, flexible films or coatings. Additionally, it is desirable that the inner surface of the outer layer is capable of forming a strong bond with the heat sealable inner sheet during, for example, the formation of the seals which form the side seams of some finished food pouches during manufacturing, as described in greater detail below. It is also preferable that the inner surface of the outer layer is suitable for being coated with a preservative, discussed below, and that the material of both the inner layer and the outer layer is non-reactive with the preservative.

The various polymer components used to fabricate multilayer films for the packaging according to the present disclosure may also contain appropriate amounts of other additives optionally included in such compositions. These include slip agents such as talc, antioxidants, fillers, dyes, pigments, radiation stabilizers, antistatic agents, elastomers, and other such additives known to those of skill in the art of packaging films. An antifog agent is a preferred additive for at least one of the outer layers, especially when the packaging is for fresh produce, which has a tendency to result in undesirable fogging of the bag.

In further embodiments of the packaging of the present disclosure, the multilayer film of the bag or packaging can include a tear notch, pull tab, tear strip, or other opening system, so that the package is an easy-open package. Other opening systems, such as perforation lines, and the like, are well known in the art and may also be used for this purpose. The preservative layer 18 of the bag according to the present disclosure is made of one or more preservatives. Preferably, the preservative comprises one or more natural preservatives, although synthetic preservatives (also known as “chemical preservatives”) (e.g., nitrates, nitrites, EDTA, sodium benzoate, potassium sorbate, and sulfites such as sulfur dioxide) may be used. As used herein the term “natural preservative” refers to a composition with preservative properties that is obtained from a naturally available source, such as a plant source, as opposed to being synthesized by man. In an exemplary embodiment, the natural preservative is a naturally occurring acid that serves to maintain a desired pH level within the package. By maintaining the pH level at or below around 6.9, the growth and migration of pathogens, such as bacteria, that cause decomposition of, for example, fresh meat and produce products, is inhibited. Thus product shelf-life is extended beyond that provided by conventional packaging that does not include the preservative layer. Furthermore, since the preservative is contained between bag layers 12 and 14 and reaches the food product contained in the interior of the bag in the form of a vapor, this diminishes any “off” flavoring that may be imparted by the preservative while still maintaining the antimicrobial and/or anti-enzymatic activity of the preservative in an exemplary embodiment, the inner surface of the outer layer of the bag is coated with one or more preservatives.

Suitable natural preservatives for use in the packaging of the present disclosure include naturally occurring acids such as citric acid and acetic acid, salts thereof such as sodium citrate and phosphoric acetate, anhydride forms thereof, and mixtures of such acids, salts and/or anhydride forms. For many products citric acid may be preferred over acetic acid because of its more pleasing taste and odor. The natural preservative(s) can be applied to or coated on outer layer 12 in the form of a composition including an oxidation reduction agent compatible with the preservative(s). The natural preservatives can be applied in the form of a paste, gel, powder, aerosol, liquid or solid. When in the form of a paste, gel, aerosol, or liquid, a vehicle (such as water) can be included. In one form, the preservative is a dried mixture of citric acid, distilled water, and a yellow dye that is applied as a coating on the inner surface of outer layer 12 of the bag. In an alternative embodiment, the preservative(s) can be applied to the outer surface of the inner layer 14 of the bag.

The preservative-containing, multi-layered food packaging bag described above can be manufactured according to standard methods known for manufacturing multi-layered bags and pouches for containing food products. Such methods are described, for example, in U.S. Pat. Nos. 3,559,800, 4,481,669 and 4,778,557 which are hereby incorporated by reference. In a conventional manner of constructing multilayer bags, the layers are joined and secured together to form a laminated web prior to forming the bag construction. The layers may be completely laminated, if such process does not interfere with the preservative layer, or the layers may be secured together by laminating/bonding the layers in selected intervals or areas (e.g., at the edges and/or in a pattern, such as a quilt-like pattern) along the layers, for example, to leave un-bonded, “preservative pockets” between the bonded areas.

In such a process, the first (or inner) layer is provided, and a second (outer) layer is provided. The preservative is applied to a surface of one of the two layers, the layers are placed together so that the preservative is between the layers, and the layers are secured together as described above. Preferably the preservative layer is applied to the inner surface of the outer layer prior to securing the outer and inner layers together to form the laminated web. The second, or outer, layer may include additional outer layers. Subsequently, the laminated web is formed into multiple bags/pouches as described in the above patents or by other conventional variations of this method known in the art. The bags can then be filled and sealed for shipping in a conventional “form, fill, and seal” operation, as known to those of skill in the art.

When forming the laminate web, preferably, the layers of the bag/film material are bonded together by adhesive and/or heat and pressure sealing. In other embodiments the layers may be bonded together via an irradiation process. In such a process the film is subjected to an energetic radiation treatment, such as corona discharge, plasma, flame, ultraviolet, X-ray, gamma ray, beta ray, and high energy electron treatment, which induce cross-linking between molecules of the irradiated material.

In an alternate embodiment of the food packaging of the present disclosure, a multi-layer food packaging film is provided. The film is constructed as described above in the form of a bag or pouch, with inner and outer layers and preservative layer disposed therebetween. The packaging film is also suitable as a cover or overwrap for foods packaged in a tray or container and provides an extended shelf-life for foods in a package covered with the preservative-containing film.

Similar to the bag, the inner layer of the film would be made of a porous, semi-permeable, “breathable,” or otherwise water-vapor permeable material, as described above, to allow moisture from the food product to be in communication with the preservative layer. The outer layer(s) would be made of a material suitable for the use of the film, and should be non-reactive with the preservative material. An example is Cryovac BDF-2001 film that is a multi-layered, coextruded polyolefin shrink film with good aroma and oxygen barrier properties, offered by Sealed Air Corporation, Duncan, S.C. If desired, the material for the film layers can be a clear plastic film allowing the food product to be seen and displayed in the packaging.

Embodiments of the present disclosure also include methods of packaging a food product in the bag/pouch or with the film of the present disclosure. In an embodiment a food item (such as, but not limited to, fresh, uncooked meat, fresh produce, fresh baked goods, and the like) is packaged in a multi-layered, preservative-containing bag/pouch of the present disclosure to extend the shelf life of the food product. In another embodiment a food item is wrapped with the multi-layered, preservative-containing film of the present disclosure, or placed in a tray or other suitable container and then wrapped with the film to extend the shelf life of the food product.

It can be seen from the above description that a packaging system and methods of packaging foods are provided, which include the use of one or more preservatives for extending the shelf-life of fresh food products such as fresh meat and produce. A multi-layered food packaging bag or pouch for extending the shelf-life of fresh food products is also provided. Additionally, a multi-layered food packaging film or overwrap for use in conventional food packaging is provided.

It should be emphasized that the above-described embodiments of the present packaging apparatus, particularly, any “preferred” embodiments, are merely possible examples of implementations and merely set forth for a clear understanding of the principles of the invention. Many variations and modifications may be made to the above-described embodiment(s) without departing substantially from the spirit and principles of the invention. All such modifications and variations are intended to be included herein within the scope of this disclosure and protected by the following claims.

1. A bag for packaging a food product comprising:
an inner layer defining an interior compartment for receiving the food product, wherein the inner layer is semi-permeable to moisture and gas;
at least one outer layer, wherein the outer layer is substantially impermeable to moisture; and
a preservative disposed between the inner layer and the outer layer.

2. The bag of claim 1, wherein the preservative comprises a natural preservative.

3. The bag of claim 1, wherein the preservative comprises citric acid.

4. The bag of claim 1, wherein the preservative is a pH adjusting preservative.

5. The bag of claim 4, wherein the pH adjusting preservative serves to maintain the pH level within the bag at or below around 6.9.

6. The bag of claim 1, wherein the outer layer is substantially impermeable to gas.

7. The bag of claim 1, wherein moisture from the food product diffuses through the inner layer of the bag and interacts with the preservative layer to produce a preservative-containing vapor.

8. The bag of claim 7, wherein the moisture from the food product is in the form of water vapor.

9. The bag of claim 7, wherein the preservative-containing vapor extends a shelf-life of the food product.

10. A film for packaging a food product comprising:
an inner layer defining an interior compartment for receiving the food product, wherein the inner layer is semi-permeable to moisture and gas;
at least one outer layer, wherein the outer layer is substantially impermeable to moisture; and
a preservative disposed between the inner layer and the outer layer.

11. The film of claim 10, wherein the film is used to cover a food item in a container.

12. The film of claim 10, wherein moisture from the food product diffuses through the inner layer of the bag and interacts with the preservative to produce a preservative-containing vapor.

13. The film of claim 12, wherein the moisture comprises water vapor.

14. The bag of claim 10, wherein the preservative is a pH adjusting preservative.

15. The bag of claim 10, wherein the preservative comprises citric acid.

16. A method of making a food packaging material comprising:
providing a first layer, wherein the first layer is semi-permeable to moisture and gas;
providing a second layer, wherein the second layer is substantially impermeable to moisture;
applying a preservative to a surface of one of the first and second layers;
placing the first and second layers together, so that the preservative is located between the layers; and
securing the layers together.

17. The method of claim 16, wherein the layers are secured together by a process selected from: laminating, heat bonding, heat sealing, pressure sealing, and irradiation.

18. The method of claim 16, wherein the layers are secured together with an adhesive, wherein the adhesive does not react with the preservative.

19. The method of claim 16, wherein the layers are secured together by providing seals at selected intervals along the layers.

20. The method of claim 16, further comprising forming the material into bags.

21. The method of claim 16, further comprising forming the material into a film.

22. The method of claim 16, wherein the preservative comprises a natural preservative.

23. The method of claim 16, wherein the preservative comprises citric acid.

24. The method of claim 16, wherein the preservative is a pH adjusting preservative.

25. The method of claim 24, wherein the pH adjusting preservative serves to maintain the pH level within the bag at or below around 6.9.

26. The method of claim 16, wherein the second layer is substantially impermeable to gas.

27. The method of claim 16, wherein the second layer may include multiple layers.

28. The method of claim 16, wherein the moisture comprises water vapor.
